(19) United States
(12) Patent Application Publication
(10) Pub. No.: US 2026/0177495 A1
(43) Pub. Date: Jun. 25, 2026

(54) FOCUS TRACKING TECHNIQUES FOR INSPECTION SYSTEM

(71) Applicant: Onto Innovation Inc., Wilmington, MA (US)

(72) Inventor: Noah Christopher Bock, Blaine, MN (US)

(21) Appl. No.: 18/989,254

(22) Filed: Dec. 20, 2024

(51) Int. Cl. G01N 21/88; G01N 21/95

(52) U.S. Cl. CPC G01N 21/8806; G01N 21/9501; G01N 2201/0636; G01N 2201/0638; G01N 2201/1087; G01N 2201/11

(57) ABSTRACT

An improved focus tracking system for an inspection system that positions a line ahead of the imaging field of view in the scan direction and dynamically actuates an optical element to reposition the line when the scan direction changes is provided. Current systems fail to provide leading focus information or adjust to allow for a high-speed scan. The focus tracking system may be used in inspection systems for substrates such as panels and wafers, through-glass vias (TGVs), as well as various electronic devices.

### FIELD OF THE DISCLOSURE

This disclosure relates generally to inspection systems and, more particularly, to techniques for the inspection of semiconductors and electronic devices.

### BACKGROUND

Inspection is an important step in electronics and semiconductor manufacturing and is aimed at detecting defects, such as flaws or irregularities, on wafers or other articles under inspection during various stages of production. These defects may be the result of contamination or mechanical damage, for example. The smallest imperfections on a wafer, for example, may impact the functionality and performance of individual chips.

Modern inspection systems are designed to detect a wide range of defects, such as residue, scratches, and warping, for example. Inspection systems scan the article under inspection using light-based imaging techniques to spot visible defects.

One goal of defect inspection is to maintain high production yields by minimizing the number of faulty chips, for example. By identifying and analyzing defect patterns, manufacturers may identify sources of contamination or process errors and make necessary adjustments to improve overall efficiency.

### SUMMARY OF THE DISCLOSURE

This disclosure is directed to an improved focus tracking system for an inspection system that positions a line ahead of the imaging field of view in the scan direction and dynamically actuates an optical element to reposition the line when the scan direction changes. Current systems fail to provide leading focus information or adjust to allow for a high-speed scan. The focus tracking system may be used in inspection systems for substrates such as panels and wafers, through-glass vias (TGVs), as well as various electronic devices.

In some aspects, this disclosure is directed to a focus tracking system for an inspection system that improves focus information and adjusts positions in a scan, the focus tracking system comprising: an optical displacement sensor configured to generate light in the form of a line; an optical element configured to project the line onto a surface of an article under inspection; a position sensing device configured to detect light representing a reflected line from the surface of the article under inspection; and a controller configured to: position at least a portion of the light representing the line ahead of an imaging field of view in a scan direction; adjust, using the at least a portion of the line ahead of the imaging field of view in the scan direction, a focus of the inspection system based on data from the position sensing device; and adjust a position of the optical element to reposition the line when a scan direction changes.

In some aspects, this disclosure is directed to a method for focus tracking in an inspection system that improves focus information and adjusts positions in a scan, the method comprising: projecting light representing a line onto a surface of an article under inspection; positioning at least a portion of the light representing the line ahead of an imaging field of view in a scan direction; adjusting, using reflected light from the at least a portion of the line ahead of the imaging field of view in the scan direction, a focus of the inspection system; and adjusting a position of an optical element to reposition the line when a scan direction changes.

In some aspects, this disclosure is directed to an inspection system comprising: a microscope having a lens with an imaging field of view for capturing images of a surface of an article under inspection; and a focus tracking system including: an optical displacement sensor configured to generate light in the form of a line; an optical element configured to project the line onto a surface of an article under inspection; a position sensing device configured to detect light representing a reflected line from the surface of the article under inspection; and a controller configured to: position at least a portion of the light representing the line ahead of an imaging field of view in a scan direction; adjust, using the at least a portion of the line ahead of the imaging field of view in the scan direction, a focus of the inspection system based on data from the position sensing device; and adjust a position of the optical element to reposition the line when a scan direction changes.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a simplified block diagram of an example of an optical inspection system that may implement various techniques of this disclosure.

FIG. 2A is a conceptual diagram depicting a line generated by an optical displacement sensor of a focus tracking system and positioned ahead of an imaging field of view in a scan direction of a focus tracking system in accordance with various techniques of this disclosure.

FIG. 2B is another conceptual diagram depicting a line generated by an optical displacement sensor of a focus tracking system and positioned ahead of an imaging field of view in a scan direction of a focus tracking system in accordance with various techniques of this disclosure.

FIG. 3 is a flow diagram of an example of a method for focus tracking in an inspection system using various techniques of this disclosure.

### DETAILED DESCRIPTION

To maintain precise focus on a semiconductor wafer or other article under inspection, inspection systems include a focus tracking system. The focus tracking system automatically adjusts the focus of the inspection system to account for changes in, for example, the wafer's topography as the wafer is scanned.

The present inventor has recognized that existing focus tracking systems face several challenges that limit their effectiveness during high-speed scanning. Many existing focus tracking systems use a single, static laser line projected diagonally across the imaging field of view of the inspection system. This approach provides a mix of leading, current, and trailing focus information. However, the trailing information is essentially useless for maintaining focus, while the current information offers limited opportunity for proactive focus adjustment.

Some existing autofocus systems utilize dual-line configurations, with separate leading and trailing lines. While this technique improves the availability of predictive focus data, it may be susceptible to errors when encountering various die features, e.g., the spaces between the dies, that may confuse the focus detection. More complex multi-line or grid-based systems have been developed to address these issues, but they often require significant computational resources to process the increased data volume and may still struggle with certain wafer topographies, for example. Additionally, many existing systems cannot adapt their focus detection pattern based on scan direction, leading to suboptimal performance during bi-directional scanning operations. Based on these challenges with existing systems, the present inventor has recognized a need for an improved focus tracking system for an inspection system.

This disclosure is directed to an improved focus tracking system for an inspection system that positions a line ahead of the imaging field of view in the scan direction and dynamically actuates an optical element to reposition the line when the scan direction changes. Current systems fail to provide leading focus information or adjust to allow for a high-speed scan. The focus tracking system may be used in inspection systems for substrates such as panels and wafers, through-glass vias (TGVs), as well as various electronic devices.

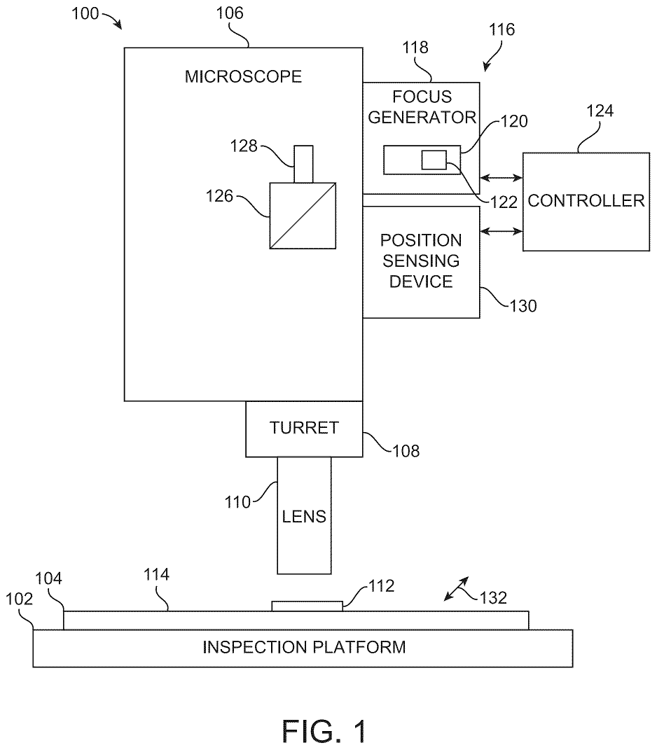

FIG. 1 is a simplified block diagram of an example of an optical inspection system that may implement various techniques of this disclosure. The optical inspection system 100 is designed for the inspection of articles such as semiconductor wafers, through-glass vias (TGVs), as well as electronic devices, and substrates. The inspection system 100 includes an inspection platform 102 for supporting an article under inspection 104. The inspection platform 102 is configured for moving horizontally in an x-y plane.

The inspection system 100 further includes a microscope 106 having an objective turret 108 and an objective lens 110. The objective turret 108 may store different optical filters and objective lenses and allows for the selection and switching between different filters and/or objective lenses.

The objective lens 110 has an imaging field of view 112, which refers to the area that may be observed by the microscope 106 through the objective lens 110 at any given moment and determines how much of the article under inspection 104 may be inspected at that moment. In some examples, the imaging field of view 112 is a time-delayed integration (TDI) imaging field of view. The objective lens 110 magnifies the image of the article under inspection 104, thereby providing detailed views of the article under inspection 104 within the imaging field of view 112 for thorough inspection.

To maintain focus on an uneven surface 114 of the article under inspection 104, the inspection system 100 includes a focus tracking system 116. The focus tracking system 116 includes a focus generator 118 coupled with a controller 124. The focus generator 118 includes an optical displacement sensor 120 that is configured for generating light via a light source 122, e.g., a laser diode, in response to signals from the controller 124. For example, the optical displacement sensor 120 may include a triangulation sensor configured for projecting light, e.g., laser light, in the form of or representing a line onto the surface 114 of the article under inspection 104. In some examples, the projected light is in the form of one or more focus spots rather than a focus line.

The focus tracking system 116 includes an optical element 126, such as a mirror or prism, configured for projecting the light representing the line (or one or more focus spots) generated by the optical displacement sensor 120 onto the surface 114 of the article under inspection 104 via the objective turret 108 and the objective lens 110. In some examples, the optical element 126 includes a wavelength-selective beam splitter configured for directing the line to the surface 114 of the article under inspection 104 and directing light representing the reflected line to a position sensing device 130 of the focus tracking system 116.

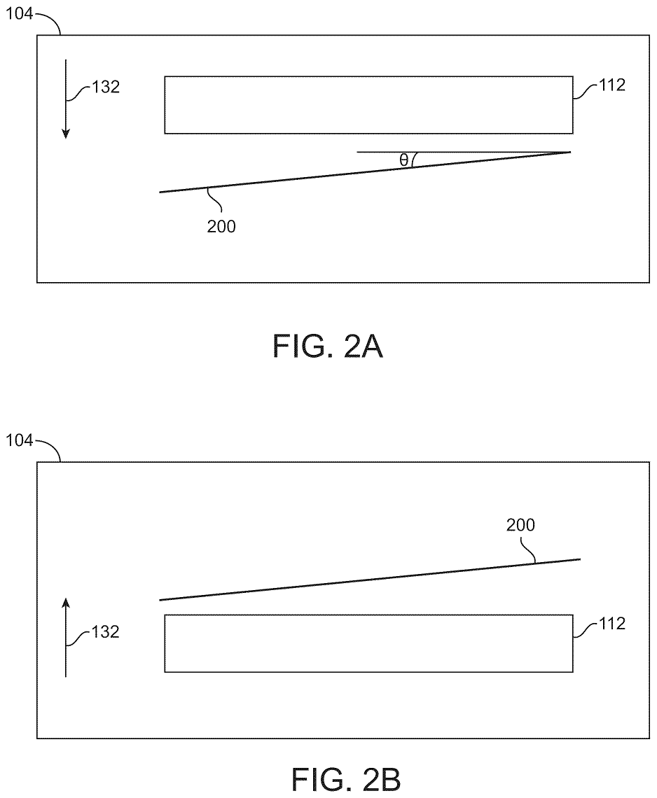

The line and the imaging field of view 112 are shown in more detail with respect to FIG. 2A. The optical element 126 is coupled with an actuator 128 configured for adjusting the position of the optical element 126. In some examples, the actuator 128 is a multi-position actuator and may adjust the optical element 126 so as to position the optical element 126 in two or more positions.

The position sensing device 130, such as including a photodetector having a linear array of pixels, is configured for detecting the light representing the line (or one or more focus spots) reflected from the surface 114 of the article under inspection 104. Light reflecting from the surface 114 in response to the light of the line hits the position sensing device 130 at an angle, and the angle changes depending on the height of the article under inspection 104. The position sensing device 130 generates signals representing the position of the reflected line and outputs those signals to the controller 124.

The controller 124 converts the received signals into position information and calculates a change in relative height based on the position of the reflected light on the position sensing device 130. In response to the change in height, the controller 124 then generates and outputs signals to a z-axis actuator to adjust the vertical z-axis of one or more components of the inspection system 100 in real-time to account for changes in the height of the article under inspection 104 as the inspection platform 102 moves horizontally in the x-y plane along a scan direction 132 within the imaging field of view 112. In this manner, the focus tracking system 116 ensures that the inspection system 100 maintains its focus even if the surface 114 of the article under inspection 104 varies in height.

In accordance with this disclosure and as described in more detail with respect FIG. 2A, the controller 124 is configured for positioning light representing at least a portion of a single line (or one or more focus spots) ahead of the imaging field of view 112 in the scan direction 132. In some examples, the entire line (or one or more focus spots) is positioned ahead of the imaging field of view. In some examples, the single line (or one or more focus spots)does not also cut across the imaging field of view of view. In this manner, the single line (or one or more focus spots) positioned ahead of the imaging field of view 112 provides leading, e.g., predictive, focus information. This is in contrast to existing approaches where the optical displacement sensor 120 provides a mix of leading, current, and trailing focus information. It is also in contrast to some existing focus tracking systems with dual-line configurations, with separate leading and trailing lines.

Then, based on data from the position sensing device 130 that used only the portion of the line (or one or more focus spots) ahead of the imaging field of view in the scan direction, the controller 124 adjusts a focus of the inspection system 100, as needed. For example, if the controller determines that the height of the surface 114 of the article under inspection 104 has changed, such as due to warping of the article under inspection 104 or the presence of residue, the controller 124 generates signals to adjust the vertical z-axis of one or more components of the inspection system 100 in real-time so that the focus is maintained.

FIG. 2A is a conceptual diagram depicting a single line generated by an optical displacement sensor of a focus tracking system and positioned ahead of an imaging field of view in a scan direction of a focus tracking system in accordance with various techniques of this disclosure. The light generated by an optical displacement sensor, such as the optical displacement sensor 120 of FIG. 1, is shown in the form of a single line 200. The imaging field of view is moving along the surface of the article under inspection 104 in the direction of the scan direction 132.

A controller, such as the controller 124 of the focus tracking system 116 of FIG. 1, controls the optical displacement sensor so as to position the light forming the line 200 ahead or in front of the imaging field of view 112 in the scan direction 132 as the article under inspection 104 is inspected. A position sensing device, such as the position sensing device 130 of FIG. 1, detects light representing a reflected line from the surface of the article under inspection. Then, the controller adjusts, using reflected light representing the portion of the line ahead of the imaging field of view in the scan direction, a focus of the inspection system.

In this manner, the single line 200 positioned ahead of the imaging field of view 112 provides only leading, e.g., predictive, focus information. The controller 124 ignores focus information from areas of the surface of the article under inspection that have already been scanned, e.g., past information from portions of the line behind the imaging field of view 112. The controller 124 also ignores focus information from areas of the surface of the article under inspection that are currently being scanned, e.g., portions of the line in the imaging field of view 112.

In some examples, the optical displacement sensor projects the line 200 at an angle θ relative to the imaging field of view 112, where θ is greater than 0. In other examples, the optical displacement sensor projects the line 200 parallel with the imaging field of view 112 such that the angle θ is 0.

By using the leading focus information, the controller may, as needed, adjust the focus of the inspection system based on data from the position sensing device, such as the position sensing device 130 of FIG. 1.

FIG. 2B is another conceptual diagram depicting a single line generated by an optical displacement sensor of a focus tracking system and positioned ahead of an imaging field of view in a scan direction of a focus tracking system in accordance with various techniques of this disclosure. FIG. 2B depicts many of the same features that are shown and described with respect to FIG. 2A and for brevity, those features will not be described in detail again.

In FIG. 2B, the scan direction 132 has changed, e.g., reversed direction from the scan direction 132 of FIG. 2A. In response, the controller of the focus tracking system adjusts a position of an optical element, such as the optical element 126 of FIG. 1, to reposition the line 200. For example, when the scan direction changes, the controller 124 of FIG. 1 generates and outputs a signal to the multi-position actuator 128 and, in response, the actuator 128 adjusts the position of the optical element 126 from a first position to a second position so as to dynamically reposition the line 200 ahead of the imaging field of view 112 in the scan direction 132. As a non-limiting example, the actuator 128 may adjust the angle of a mirror to reposition the line 200 from a first position to a second position ahead of the imaging field of view 112. This actuation allows the system to adapt to changes in the scan direction without the need for generating and projecting light representing two lines at a given time, for example.

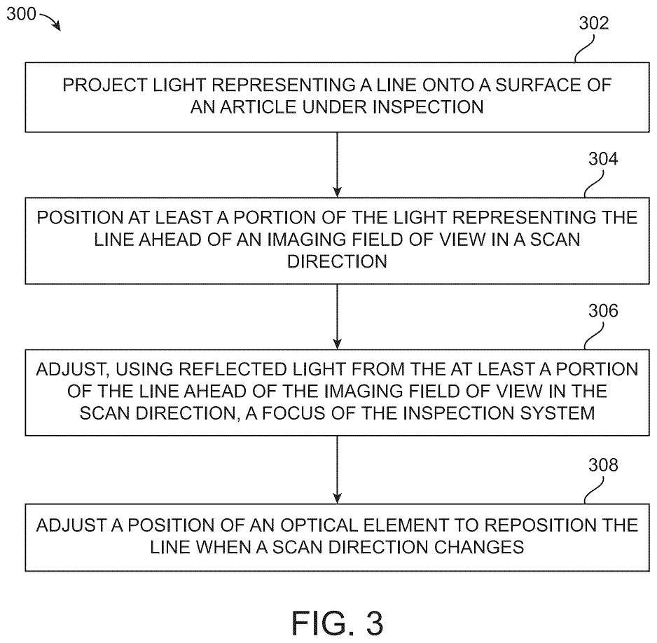

FIG. 3 is a flow diagram of an example of a method 300 for focus tracking in an inspection system using various techniques of this disclosure. In some examples, the inspection system 100 of FIG. 1 may implement the method 300.

At block 302, the method 300 includes projecting light representing a line onto a surface of an article under inspection. For example, an optical displacement sensor, such as the optical displacement sensor 120 of FIG. 1, is configured to generate light in the form of a line and an optical element, such as the optical element 126 of FIG. 1, is configured to project the line onto a surface of an article under inspection, such as the line 200 on a surface of the article under inspection 104 in FIG. 2A.

At block 304, the method 300 includes positioning at least a portion of the light representing the line ahead of an imaging field of view in a scan direction. For example, a controller, such as the controller 124 of FIG. 1, is configured to position at least a portion of the light representing the line ahead of an imaging field of view in a scan direction, such as the line 200 positioned ahead of the imaging field of view 112 in the scan direction 132 of FIG. 2A.

At block 306, the method 300 includes adjusting, using reflected light from the at least a portion of the line ahead of the imaging field of view in the scan direction, a focus of the inspection system. For example, a position sensing device, such as the position sensing device 130 of FIG. 1, detects light representing a reflected line from the surface of the article under inspection. Then, the controller adjusts, using reflected light representing the portion of the line ahead of the imaging field of view in the scan direction, a focus of the inspection system. For example, the controller generates and outputs signals to a z-axis actuator to adjust the vertical z-axis of one or more components of the inspection system 100 in real-time to account for changes in the height of the article under inspection 104 as the inspection platform 102 moves horizontal in the x-y plane along a scan direction 132 within the imaging field of view 112.

At block 308, the method 300 includes adjusting a position of an optical element to reposition the line when a scan direction changes. For example, when the scan direction 132 changes, as shown between FIG. 2A and FIG. 2B, the controller 124 of FIG. 1 generates and outputs a signal to the multi-position actuator 128 and, in response, the actuator 128 adjusts the position of the optical element 126 to dynamically reposition the line 200 ahead of the imaging field of view 112 in the scan direction 132.

In some examples, projecting the light representing the line onto the surface of the article under inspection includes projecting the light representing the line at an angle relative to the imaging field of view.

In some examples, adjusting the position of the optical element to reposition the line when the scan direction changes includes adjusting the position of a mirror, prism, or wavelength-selective beam splitter.

In some examples, positioning at least a portion of the light representing the line ahead of the imaging field of view in the scan direction includes positioning the entire line ahead of the imaging field of view in the scan direction.

In some examples, adjusting, using at least a portion of the line ahead of the imaging field of view in the scan direction, a focus of the inspection system includes adjusting, using only the portion of the line positioned ahead of the imaging field of view in the scan direction, the focus of the inspection system.

In some examples, the method 300 includes ignoring focus information from areas of the surface of the article under inspection that have already been scanned.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A focus tracking system for an inspection system that improves focus information and adjusts positions in a scan, the focus tracking system comprising:
an optical displacement sensor configured to generate light in the form of a line;
an optical element configured to project the line onto a surface of an article under inspection;
a position sensing device configured to detect light representing a reflected line from the surface of the article under inspection; and
a controller configured to:
position at least a portion of the light representing the line ahead of an imaging field of view in a scan direction;
adjust, using the at least a portion of the line ahead of the imaging field of view in the scan direction, a focus of the inspection system based on data from the position sensing device; and
adjust a position of the optical element to reposition the line when a scan direction changes.

2. The focus tracking system of claim 1, wherein the controller configured to position the at least a portion of the light representing the line ahead of the imaging field of view in the scan direction is configured to:
position the entire line ahead of an imaging field of view in a scan direction.

3. The focus tracking system of claim 1, wherein the controller configured to adjust, using the at least the portion of the line ahead of the imaging field of view in the scan direction, the focus of the inspection system based on data from the position sensing device is configured to:
adjust, using only the portion of the line positioned ahead of the imaging field of view in the scan direction, the focus of the inspection system.

4. The focus tracking system of claim 1, wherein the optical element includes a mirror or prism coupled with an actuator, and wherein the controller configured to adjust the position of the optical element to reposition the line when the scan direction changes is configured to:
adjust a position of the mirror or prism.

5. The focus tracking system of claim 1, wherein the optical element includes a wavelength-selective beam splitter coupled with an actuator, and wherein the controller configured to adjust the position of the optical element to reposition the line when the scan direction changes is configured to:
adjust a position of the wavelength-selective beam splitter.

6. The focus tracking system of claim 1, wherein the optical element is configured to project the line at an angle relative to the imaging field of view.

7. The focus tracking system of claim 1, wherein the controller is further configured for:
ignoring focus information from areas of the surface of the article under inspection that have already been scanned or are currently being scanned.

8. A method for focus tracking in an inspection system that improves focus information and adjusts positions in a scan, the method comprising:
projecting light representing a line onto a surface of an article under inspection;
positioning at least a portion of the light representing the line ahead of an imaging field of view in a scan direction;
adjusting, using reflected light from the at least a portion of the line ahead of the imaging field of view in the scan direction, a focus of the inspection system; and
adjusting a position of an optical element to reposition the line when a scan direction changes.

9. The method of claim 8, wherein projecting the light representing the line onto the surface of the article under inspection includes:
projecting the light representing the line at an angle relative to the imaging field of view.

10. The method of claim 8, wherein adjusting the position of the optical element to reposition the line when the scan direction changes includes:
adjusting the position of a mirror or prism.

11. The method of claim 8, wherein positioning the at least a portion of the light representing the line ahead of the imaging field of view in the scan direction includes:
positioning the entire line ahead of the imaging field of view in the scan direction.

12. The method of claim 8, wherein adjusting, using the at least a portion of the line ahead of the imaging field of view in the scan direction, a focus of the inspection system includes:
adjusting, using only the portion of the line positioned ahead of the imaging field of view in the scan direction, the focus of the inspection system.

13. The method of claim 8, comprising:
ignoring focus information from areas of the surface of the article under inspection that have already been scanned or are currently being scanned.

14. An inspection system comprising:
a microscope having a lens with an imaging field of view for capturing images of a surface of an article under inspection; and
a focus tracking system including:
an optical displacement sensor configured to generate light in the form of a line;
an optical element configured to project the line onto a surface of an article under inspection;
a position sensing device configured to detect light representing a reflected line from the surface of the article under inspection; and
a controller configured to:
position at least a portion of the light representing the line ahead of an imaging field of view in a scan direction;
adjust, using the at least a portion of the line ahead of the imaging field of view in the scan direction, a focus of the inspection system based on data from the position sensing device; and
adjust a position of the optical element to reposition the line when a scan direction changes.

15. The inspection system of claim 14, wherein the controller configured to position the at least a portion of the light representing the line ahead of the imaging field of view in the scan direction is configured to:
position the entire line ahead of an imaging field of view in a scan direction.

16. The inspection system of claim 14, wherein the controller configured to adjust, using the at least the portion of the line ahead of the imaging field of view in the scan direction, the focus of the inspection system based on data from the position sensing device is configured to:
adjust, using only the portion of the line positioned ahead of the imaging field of view in the scan direction, the focus of the inspection system.

17. The inspection system of claim 14, wherein the controller is further configured for:
ignoring focus information from areas of the surface of the article under inspection that have already been scanned or are currently being scanned.

18. The inspection system of claim 14, wherein the optical element includes a mirror or prism coupled with an actuator, and wherein the controller configured to adjust the position of the optical element to reposition the line when the scan direction changes is configured to:
adjust a position of the mirror or prism.

19. The inspection system of claim 14, wherein the optical element is configured to project the line at an angle relative to the imaging field of view.

20. The inspection system of claim 14, wherein the focus tracking system includes a wavelength-selective beam splitter to separate the line from visible light used for imaging.
